(19) United States
(12) Patent Application Publication
(10) Pub. No.: US 2025/0150973 A1
(43) Pub. Date: May 8, 2025

(54) SYSTEMS AND METHODS FOR ON/OFF STATE CONTROL FOR NETWORK NODES

(71) Applicant: ZTE CORPORATION, Shenzhen (CN)

(72) Inventors: Ziyang LI, Shenzhen (CN); Nan ZHANG, Shenzhen (CN); Wei CAO, Shenzhen (CN); Hanqing XU, Shenzhen (CN); Linxi HU, Shenzhen (CN)

(73) Assignee: ZTE CORPORATION, Shenzhen (CN)

(21) Appl. No.: 19/015,242

(22) Filed: Jan. 9, 2025

Related U.S. Application Data
(63) Continuation of application No. PCT/CN2022/111235, filed on Aug. 9, 2022.

(51) Int. Cl. H04W 52/02; H04W 72/0446; H04W 72/231

(52) U.S. Cl. CPC H04W 52/0274; H04W 52/0229; H04W 72/0446; H04W 72/231

(57) ABSTRACT

Presented are systems and methods for on/off state control for network nodes. A network node can receive an on/off indication from a wireless communication node. The network node can determine, according to the on/off indication, an on/off state of the network node to support signal forwarding of one or more signals.

### CROSS-REFERENCE TO RELATED APPLICATION

This application claims the benefit of priority under 35 U.S.C. § 120 as a continuation of PCT Patent Application No. PCT/CN2022/111235, filed on Aug. 9, 2022, the disclosure of which is incorporated herein by reference in its entirety.

### TECHNICAL FIELD

The disclosure relates generally to wireless communications, including but not limited to systems and methods for on/off state control for network nodes.

### BACKGROUND

Coverage is a fundamental aspect of cellular network deployments. Mobile operators rely on different types of network nodes to offer blanket coverage in their deployments. As a result, new types of network nodes have been considered to increase the flexibility of mobile operators for their network deployments. For example, certain systems or architecture introduce integrated access and backhaul (IAB), which may be enhanced in certain other systems, as a new type of network node not requiring a wired backhaul. Another type of network node is the RF repeater which simply amplify-and-forward any signal that they receive. RF repeaters have seen a wide range of deployments in 2G, 3G and 4G to supplement the coverage provided by regular full-stack cells.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium. A network node (e.g., smart node (SN)) can receive an on/off indication from a wireless communication node (e.g., base station (BS) or gNB). The network node can determine, according to the on/off indication, an on/off state of the network node to support signal forwarding of one or more signals.

In some implementations, the on/off indication can comprise a first indication and a second indication. In some implementations, the on/off state can comprise at least one of: an on/off state of the network node; an on/off state of a group of network nodes; an on/off state of one or more antenna ports of the network node; an on/off state of one or more beam indexes of the network node; an on/off state of one or more serving sectors of the network node; or an on/off state of one or more components of the network node.

In some implementations, the on/off state further can comprise the on/off state of at least one of following links: a first communication link from a wireless communication node to the network node; a second communication link from the network node to the wireless communication node; a first forwarding link from the wireless communication node to the network node; a second forwarding link from the network node to the wireless communication node; a third forwarding link from the network node to the wireless communication device; or a fourth forwarding link from the wireless communication device to the network node.

In various implementations, the network node can receive one or both of the first indication and the second indication via at least one of: at least one downlink control information (DCI) signaling, at least one medium access control control element (MAC CE) signaling, at least one radio resource control (RRC) or at least one operations, administration and maintenance (OAM) signaling. In various implementations, the first indication can indicate whether or not to enable the signal forwarding for: a channel of common transmissions, or a channel of all transmissions.

In some arrangements, the channel of common transmissions can include at least one of: a synchronization signal block (SSB), a control resource set (CORESET) #0, a physical random access channel (PRACH), a system information block of type 1 (SIB1), or a group common physical downlink control channel (PDCCH). In some implementations, the network node can determine that the first indication indicates to disable the signal forwarding.

In some implementations, when the first indication indicates to disable the signal forwarding: the network node can ignore the second indication when determining the on/off state of the network node to support the signal forwarding, or the wireless communication node can withhold sending the second indication to the network node. In some arrangements, at least one of: the signal forwarding can be disabled within a duration of a time domain resource associated with the first indication, the time domain resource being implicitly determined or explicitly determined, or the signal forwarding can remain disabled until another first indication is received that indicates to enable the signal forwarding.

In some aspects, the network node can determine that the first indication indicates to enable the signal forwarding. In some implementations, the network node can determine, when the first indication indicates to enable the signal forwarding, the on/off state of the network node according to the second indication's overriding or changing of the first indication's enablement of the signal forwarding. In some cases, the network node can determine, when the first indication indicates to enable the signal forwarding, the on/off state of the network node according to an on state of an on/off pattern for a channel of common transmissions.

In certain implementations, the on/off state of the network node can be determined by adding an on portion of the on/off pattern of the channel of common transmissions, to non-overlapping on portions indicated by the second indication. In some cases, at least one of: the signal forwarding can be enabled within a duration of a time domain resource associated with the first indication, the time domain resource being implicitly determined or explicitly determined, or the signal forwarding can remain enabled until at least one of: another first indication or the second indication is received that indicates to disable the signal forwarding.

In some arrangements, the first indication can comprise at least one of: a first parameter to configure the enabling or disabling of the signal forwarding, or a second parameter to configure a time domain resource for the enabling or disabling of the signal forwarding. In some implementations, the second parameter can comprise at least one of: a start time, a pattern, a start and length indicator value (SLIV), a time offset, a time domain resource allocation (TDRA) index, a duty cycle, a duration or a periodicity.

In some implementations, the on/off indication or the second indication can comprise at least one of: an indicator to enable or disable the signal forwarding, an indicator to enable or disable the signal forwarding, the indicator associated with a time domain resource, a plurality of indicators to enable or disable the signal forwarding one or more time domain resources for the enabling or disabling of the signal forwarding, one or more parameters for discontinuous activation of the signal forwarding, beam information that is associated with a time domain resource, beam information that is not associated with any time domain resource, power control information, or configuration of discontinuous reception (DRX) for the network node.

In some implementations, the plurality of indicators to enable or disable the signal forwarding can include: a bitmap, wherein a “0” if present in the bitmap indicates to enable the signal forwarding, and a “1” if present in the bitmap indicates to disable the signal forwarding, “1” for each of the indicators, wherein each “1” indicates to enable the signal forwarding, “0” for each of the indicators, wherein each “0” indicates to disable the signal forwarding, a set of on/off states, or a predefined on/off pattern. In some implementations, each indicator of the plurality of indicators is associated with a corresponding configured time domain resource, all indicators of the plurality of indicators are associated with a same configured time domain resource, or all indicators of the plurality of indicators are associated with a predefined time domain resource.

In various aspects, a time domain resource can be specified by at least one of: a start time, a pattern, a start and length indicator value (SLIV), a time offset, a time domain resource allocation (TDRA) index, a duty cycle, a duration or a periodicity.

At least one aspect is directed to a system, method, apparatus, or a computer-readable medium. A wireless communication node (e.g., BS or gNB) can send an on/off indication to a network node (e.g., SN), causing the network node to determine, according to the on/off indication, an on/off state of the network node to support signal forwarding of one or more signals between the wireless communication node and a wireless communication device (e.g., UE).

The systems and methods presented herein include a novel approach for on/off state control for network nodes. Specifically, the systems and methods presented herein discuss a novel solution for improving the efficiency of the network node (e.g., SN) (e.g., used to extend coverage of the network) by various implementations of the on/off state(s) according to various indications/messages/signals from the BS. For example, the SN can receive/obtain/acquire a first indication/message/signal/information and a second indication from the BS. The SN can determine the on/off state of SN according to at least one of the indications.

The first indication may include at least one of the following types: enable/disable the on/off functionality of SN FU (e.g., or whole/entire channel forwarding functionality), enable/disable the functionality of common channel on/off configuration (e.g., or common channel forwarding functionality). The systems and methods of the technical solution described herein can provide or introduce behavior/characteristic of SN FU (or NCR fwd) corresponding to different types of the first indication. For example, if the first indication is to enable/disable the whole channel forwarding functionality, at least one of the following can be considered or performed:
If the first indication indicates “disabled” (e.g., false, off, or deactivated states), in some cases with an associated time domain resource (e.g., the time domain resource may be explicitly or implicitly provided/determined/indicated), within the given time domain resource, SN FU can be kept off (e.g., maintained in an off state) until SN CU receives at least one indication (e.g., another first indication) to change the SN (e.g., network node) on/off functionality. In this case, the on/off state of SN FU may not be affected by the second indication.
If the first indication indicates “enabled” (e.g., true, on, or activate, among other interchangeable terms), in some cases with an associated time domain resource (e.g., the time domain resource may be explicitly or implicitly provided/determined/indicated), within the given time domain resource, SN FU can maintain an on until SN receives a second indication. Subsequently, the SN can determine the on/off state according to the second indication and/or common channel pattern. For example, the SN FU can be on within or during the common channel pattern. Outside the common channel pattern, the SN can determine to be in an on or off state according to the on/off indication of the second indication.

In another example, if the first indication is to enable/disable common channel forwarding functionality, at least one of the following can be performed:
If the first indication indicates disabled, false, off, or deactivated, in some cases with an associated time domain resource (e.g., the time domain resource may be explicitly determined or implicitly determined), within at least one of the given time domain resource and/or common channel pattern, the SN FU can maintain its off state (e.g., SN FU may not forward common channel signals) until the SN receives another first indication. The first indication can indicate to change the SN common channel forwarding functionality/state outside of the common channel pattern (e.g., with or without a given time domain resource). The on/off state of SN FU can be determined/configured according to the second indication.
If the first indication indicates enable, true, on, or activated, in some cases with an associated time domain resource (e.g., the time domain resource may be explicitly or implicitly determined) within the given time domain resource and/or within a common channel pattern, SN FU can maintain an on state (e.g., SN can forward common channel signals) until SN CU receives another first indication. The first indication can indicate for the SN to change its common channel forwarding functionality. Outside of the common channel pattern (e.g., with or without the given time domain resource), the on/off state of SN FU can be determined according to the second indication.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates a schematic diagram of an example network, in accordance with some embodiments of the present disclosure;

FIG. 4 illustrates a schematic diagram of transmission links between BS to SN and SN to UE, in accordance with some embodiments of the present disclosure;

FIG. 5 illustrates a tree diagram of an example first on/off state control structure, in accordance with some embodiments of the present disclosure;

FIG. 6 illustrates a tree diagram of an example second on/off state control structure, in accordance with some embodiments of the present disclosure;

FIG. 7 illustrates a graph of an example single state indication, in accordance with some embodiments of the present disclosure;

FIG. 8 illustrates a graph of an example single state indication associated with a time domain resource, in accordance with some embodiments of the present disclosure;

FIG. 9 illustrates a graph of a first example multi states indication, in accordance with some embodiments of the present disclosure;

FIG. 10 illustrates a graph of a second example multi states indication, in accordance with some embodiments of the present disclosure;

FIG. 11 illustrates a graph of a third example multi states indication, in accordance with some embodiments of the present disclosure;

FIG. 12 illustrates a graph of a first example time domain resource indication, in accordance with some embodiments of the present disclosure;

FIG. 13 illustrates a graph of a second example time domain resource indication, in accordance with some embodiments of the present disclosure;

FIG. 14 illustrates graphs of an example discontinuous forwarding (DF) mode with short DF cycle and long DF cycle, in accordance with some embodiments of the present disclosure;

FIG. 15 illustrates graphs of a first example combination of whole and/or common channel forwarding functionalities, in accordance with some embodiments of the present disclosure;

FIG. 16 illustrates graphs of a second example combination of whole and/or common channel forwarding functionalities, in accordance with some embodiments of the present disclosure;

FIG. 17 illustrates graphs of a third example combination of whole and/or common channel forwarding functionalities, in accordance with some embodiments of the present disclosure;

FIG. 18 illustrates graphs of a fourth example combination of whole and/or common channel forwarding functionalities, in accordance with some embodiments of the present disclosure; and

FIG. 19 illustrates a flow diagram of an example method for on/off state control for network nodes, in accordance with an embodiment of the present disclosure.

### DETAILED DESCRIPTION

### 1. Mobile Communication Technology and Environment

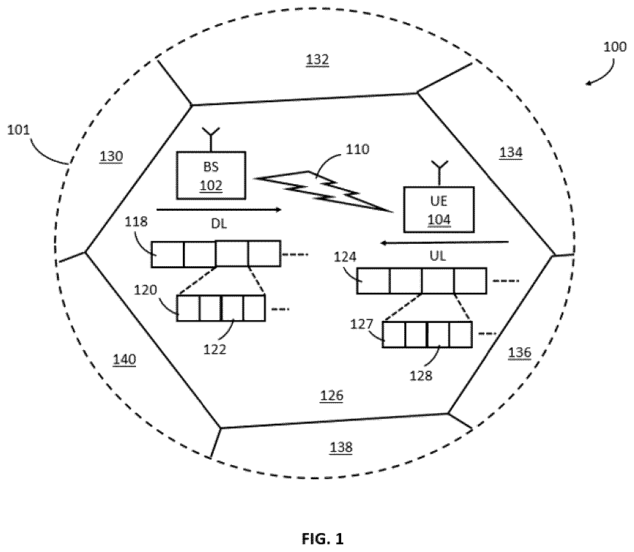

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

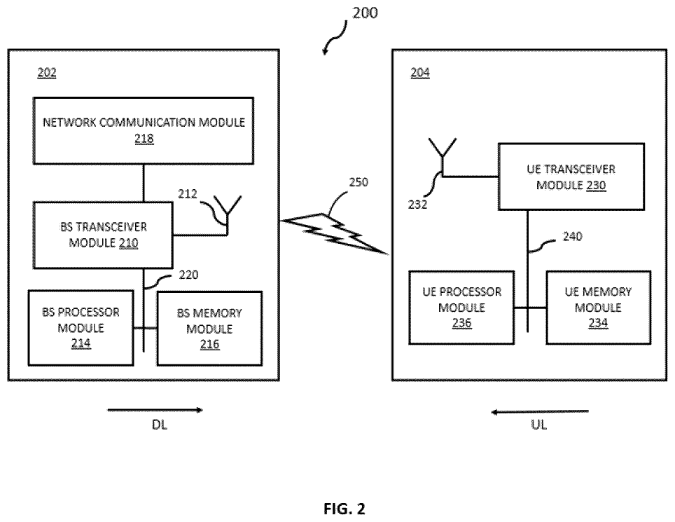

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

2. Systems and Methods for on/Off State Control for Network Nodes

In certain systems (e.g., 5G new radio (NR), Next Generation (NG) systems, 3GPP systems, and/or other systems), a network-controlled repeater can be introduced as an enhancement over conventional RF repeaters with the capability to receive and/or process side control information from the network. Side control information can allow a network-controlled repeater to perform/execute/operate its amplify-and-forward operation in a more efficient manner. Certain benefits can include at least mitigation of unnecessary noise amplification, transmissions and receptions with better spatial directivity, and/or simplified network integration.

The network-controlled repeater (NCR) can be regarded as a stepping stone of a re-configurable intelligent surface (RIS). A RIS node can adjust the phase and amplitude of the received signal to improve/enhance the coverage (e.g., network communication coverage). As discussed herein, network nodes, including and not limited to network-controlled repeater, smart repeater, Re-configuration intelligent surface (RIS), Integrated Access and Backhaul (IAB), can be denoted, referred to, or provided as a smart node (SN) (e.g., network node) for simplicity. For example, the SN can include, correspond to, or refer to a kind of network node to assist the BS 102 to improve coverage (e.g., avoiding/averting blockage/obstructions, increasing transmission range, etc.). However, due to the SNs not being aware of other SNs, the UE 104 may suffer from interference from other SNs, such as for cell-edge UEs.

To mitigate/minimize/reduce the (e.g., unexpected) interference from other SNs, the systems and methods of the technical solution discussed herein can introduce/provide/leverage a more structured (e.g., enhanced) on/off indication and/or signaling. The on/off indication can include or indicate various SN behaviors/characteristics/patterns according to at least one or a combination of on/off indication technique(s). With the on/off state control, the network (e.g., the BS 102) can explicitly or implicitly indicate/provide the on/off state/status/indication for one or more SNs, thereby alleviating the potential impact of interference during communication between the BS 102 and the UE 104 through one or more SNs (e.g., network nodes).

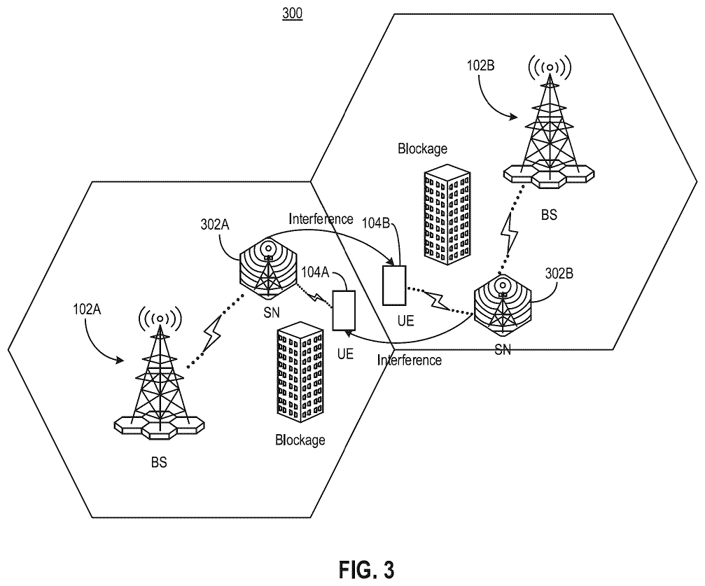

FIG. 3 illustrates a schematic diagram of an example network 300. As illustrated in FIG. 3, one or more BSs 102A-B (e.g., BSs 102) can serve one or more UEs 104A-B (e.g., UEs 104) respectively in their cells via the respective one or more SNs 302A-B (e.g., sometimes labeled as SN(s) 302), such as when there are blockages between the BS(s) 102 and the UE(s) 104. However, in some cases, the signals from an SN 302 may interfere with the communications in an adjacent cell. For example, signals from SN 302A may interfere with the communications in the cell associated with UE 104B, and/or signals from SN 302B may interfere with the communications in the cell associated with UE 104A. As such, the systems and methods discussed herein can utilize the on/off status control for the SNs to minimize at least the interferences by the signals of the SNs 302 between different cells.

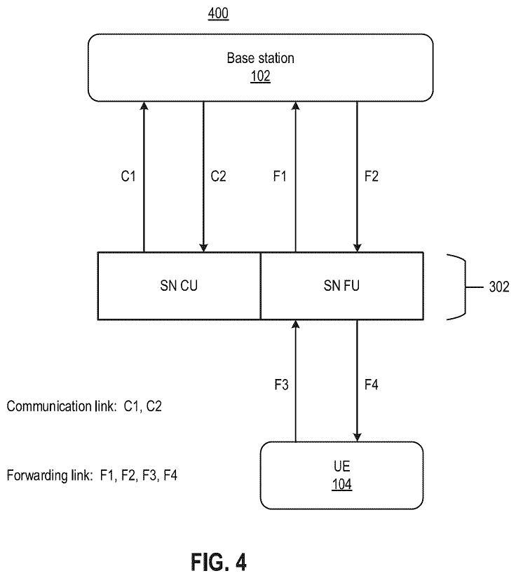

FIG. 4 illustrates a schematic diagram 400 of transmission links between BS 102 to SN 302 and SN 302 to UE 104. The SN 302 can include or consist of at least two functional parts/components, such as the communication unit (CU) (e.g., SN CU) and the forwarding unit (FU) (e.g., SN FU). For example, the SN CU can be a network-controlled repeater (NCR) MT. In another example, the SN FU can be an NCR forwarder/forwarding (Fwd). The SN CU can act/behave or include features similar to a UE 104, for instance, to receive and decode side control information from the BS 102. The SN CU may be a control unit, controller, mobile terminal (MT), part of a UE, a third-party IoT device, and so on. The SN FU can carry out the intelligent amplify-and-forward operation using the side control information received by the SN CU. The SN FU may be a radio unit (RU), a RIS, and so on.

The transmission links between the BS 102 to SN 302 and the SN 302 to UE 104 as shown in FIG. 4 can be defined/described/provided as follows:
C1: Control link from SN CU to BS;
C2: Control link from BS to SN CU;
F1: Backhaul link from SN FU to BS;
F2: Backhaul link from BS to SN FU;
F3: Access link from UE to SN FU; and
F4: Access link from SN FU to UE.

Control link (e.g., sometimes referred to as a communication link) can refer to or mean that the signal from one side will be detected and decoded by the other side, so that the information transmitting in the control link can be utilized to control the status of forwarding links (e.g., backhaul links and/or access links). Forwarding link can mean that the signal from BS 102 or UE 104 is unknown to SN FU. In this case, the SN FU can amplify and forward signals without decoding them. For example, the F1 and F3 links can correspond to or be associated with the complete uplink (UL) forwarding link (e.g., backhaul link and access link, respectively) from UE 104 to BS 102, in which F1 is the SN FU UL forwarding link. Additionally, the F2 and F4 links can correspond to or be associated with the complete downlink (DL) forwarding link (e.g., backhaul link and access link, respectively) from BS 102 to UE 104, in which F4 is the SN FU DL forwarding link. The F1 and F2 links can correspond to or be referred to as backhaul links and F3 and F4 links can correspond to or be referred to as access links.

Example Implementation: BS Transmits on/Off Indication to SN CU, and the on/Off State of SN FU Determined According to the Indication

In various arrangements, the SN 302 (e.g., network node) can receive one or more indications (e.g., a first indication and/or a second indication) from the BS 102 (e.g., gNB or wireless communication node). Subsequently, the SN 302 can determine the on/off state of the SN 302 according to at least one of the one or more indications. The one or more indications may refer to as messages or signals transmitted from the BS 102 to the SN 302, for example. In some cases, the one or more indications can be included in one message. In some other cases, the indications can be included in different messages, such as a first indication corresponding to a first message and a second indication corresponding to a second message. In some other cases, multiple messages can be a part of or combined into a single message. Although two indications are provided to the SN 302 by the BS 102, a number of additional indications may be provided to the SN 302 (e.g., in addition to the two indications) according to the configuration of the BS 102, the SN 302, and/or the UE 104, among other devices within the network.

In various implementations, the first indication can include at least one of the following types:
1. Enable/disable the on/off functionality of SN FU (e.g., the whole channel forwarding functionality, sometimes referred to as a channel for all transmissions), and/or
2. Enable/disable the functionality of common channel on/off configuration (e.g., a common channel forwarding functionality, sometimes referred to as a channel of common transmission).

The first indication can indicate whether or not to enable (or disable) the signal forwarding functionality for the channel(s), such as channel for common transmission (e.g., common channel) and/or channel for all transmission (e.g., whole channel). As discussed herein, the common channel can include at least one of a synchronization signal block (SSB), a control resource set (CORESET) #0, a physical random access channel (PRACH), a system information block of type 1 (SIB1), and/or a group common physical downlink control channel (PDCCH), among others. Further, the term/phrase “common channel on/off configuration” or “SN is on within common channel pattern” can refer to at least one of F1-F4 (or Fc1-Fc4, corresponding to forwarding functionality 1-4) of SN 302 is on, activated, or enabled within or during the common channel pattern (e.g., during the on state indicated by the common channel pattern).

For example, within SSB and/or CORESET #0 pattern, the forwarding links 2 and 4 of the SN 302 can be turned on. Within SIB 1 transmission pattern, forwarding links 2 and 4 can be turned on. Within the group common PDCCH transmission pattern, forwarding links 2 and 4 can be turned on. Within PRACH pattern, forwarding links 1 and 3 can be turned on. The SN 302 (e.g., SN CU) can receive the on/off indication (e.g., including at least one of the first indication and/or the second indication) from the BS 102. Subsequently, the SN 302 can update/change/adjust/configure the on/off state of the SN FU in epoch time (e.g., “t”) according to the on/off indication. For example, the on/off indication can include or indicate at least one of:
Starting time of the next sub-frame after SN 302 receives the indication (e.g., at least one of the first and/or second indications);
End of the sub-frame where SN 302 receives the indication;
Starting time of next frame after SN 302 receives the indication;
End of the frame where SN 302 receives the indication;
Starting time of the next slot after SN 302 receives the indication;
End of the slot where SN 302 receives the indication;
Starting time of the sub-frame, indicated by a system frame number (SFN) and a sub-frame number signaled together with the on/off indication;
Starting time of the frame, indicated by an SFN signaled together with the on/off indication;
End of SI window;
At a time instance (e.g., time period or moment) defined/provided in the specification, e.g., SFN0, SFN512, etc. The SFN0 may refer to the first frame in a super frame, and the SFN512 may refer to the 513th frame in the super frame, where the super frame can include 1024 frames;
After a fixed time duration (e.g., time offset, predetermined by or configured according to the specification) between the SN 302 receiving the indication and epoch time. This time duration or time offset can be at least one of frame level, sub-frame level, symbol level, slot level, and/or ms level, such as 1 frame, 1 sub frame, 1 slot, 1 symbol, and/or 1 ms, among others;
After a time duration or time offset between when the SN 302 receives the indication and the epoch time based on the capability/support/configuration of the SN 302;
After a time duration or time offset between when the SN 302 receives the indication and epoch time which may be configured by the BS 102 through at least one of downlink control information (DCI) signaling, medium access control control element (MAC CE) signaling, radio resource control (RRC), and/or operations, administration and maintenance (OAM) signaling, etc.

### SN FU Behavior/Characteristic—Whole Channel (e.g., Channel of all Transmissions)

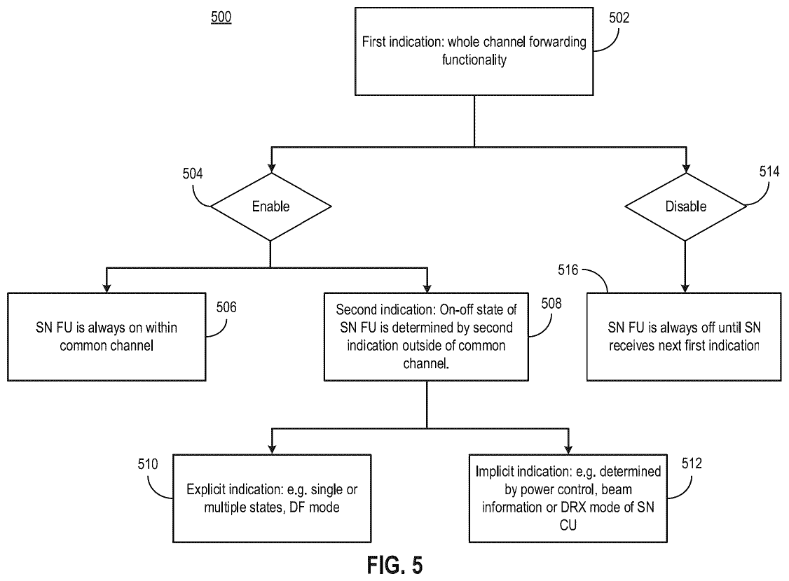

Referring to FIG. 5, depicted is a tree diagram 500 of an example first on/off state control structure (e.g., for whole channel). In various arrangements, the behavior/characteristic of SN FU (or NCR Fwd) corresponding to different types of the first indication can be shown in conjunction with at least FIG. 5. For example, the SN 302 can receive a first indication from the BS 102 (502). The first indication can be for enabling or disabling the whole channel forwarding functionality (e.g., signal forwarding for a channel of all transmissions).

In some implementations, the first indication can indicate a disable (e.g., false, off, or deactivated, etc.) state for the whole channel forwarding functionality (e.g., to disable the signal forwarding for the whole/entire channel) (514). The first indication may or may not be associated with a time domain resource. The time domain resource can be explicitly determined/indicated/provided or implicitly determined. For example, within/during the provided/given/determined time domain resource (e.g., duration of the time domain resource associated with the first indication), the SN FU can be maintained/kept in an off/disabled state (516). In some cases, the SN FU can be off until the expiration/end of the duration of the time domain resource. In this case, the SN FU may be enabled in response to the time exceeding/passing the determined duration. Additionally or alternatively, in some cases, the SN FU can maintain the disabled state until SN CU receives another indication (e.g., another first indication, such as in a separate message) to adjust/change/modify the on/off functionality of the SN 302. For example, the SN FU can remain in the disabled state until another indication to change the on/off state of the SN 302 (e.g., an indication of an on state). In various implementations, because the first indication is for disabling the whole channel forwarding functionality, as shown, the on/off state of SN FU may not be affected by the second indication (e.g., at ACT 508). Hence, in various arrangements where the first indication is for disabling signal forwarding for the channel of all transmissions, the SN 302 may ignore the second indication, reject the second indication, and/or the BS 102 may not signal/send/provide the second indication to the SN 302, such as during the duration of the time domain resource. In this case, for example, the on/off indication may include only the first indication, such as without the second indication.

In various arrangements, the first indication may indicate to enable (e.g., true state, on state, activated state, etc.) signal forwarding for the whole channel (e.g., forwarding functionality for the channel of all transmissions) (504). Similarly, in some cases, the first indication may be associated with a time domain resource, which can be determined explicitly or implicitly. The implicit and/or explicit determination of the time domain resource can be based on the configuration/support/capability of the SN 302 and/or BS 102, for example.

In some implementations, within the time domain resource, SN FU can maintain an activate state (506). The SN FU can be on within the common channel (e.g., according to the common channel pattern). In some implementations, the SN FU can be on until the SN 302 receives a second indication. For example, the SN 302 can receive a second indication (e.g., as part of the same message including the first indication or a different message) (508), which may indicate a different on/off state pattern for the SN FU. The SN 302 can determine the on/off state according to at least one of the second indication and/or the common channel pattern (e.g., SN FU may be kept on within common channel pattern, outside common channel pattern (e.g., UE-specific channel), and/or the on/off state of the SN 302 can be determined according to the on/off indication indicated in the second indication).

In some implementations, the SN 302 can receive an explicit indication for the on/off state that is outside the pattern associated with the second indication (510). The explicit indication can include at least one of single state indication, multiple states indication, DF mode, among others. In some implementations, the SN 302 can receive an implicit indication for the on/off state (512). For instance, the SN 302 can determine the on/off state of the SN FU that is outside the pattern based on the implicit indication. The implicit indication can include at least one of power control (e.g., determined based on or according to the power control), beam information, and/or discontinuous reception (DRX) mode of SN CU, among others.

### SN FU Behavior/Characteristic−Common Channel (e.g., Channel of Common Transmissions)

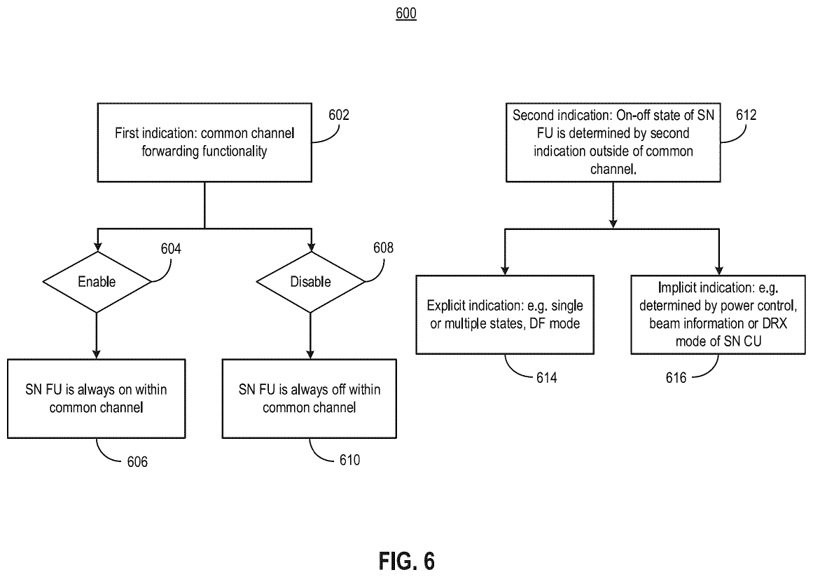

Referring to FIG. 6, depicted is a tree diagram 600 of an example second on/off state control structure (e.g., for common channel). In various arrangements, the first indication can indicate to enable (e.g., turn on or activate) or disable (e.g., turn off or deactivate) the forwarding functionality (e.g., signal forwarding) of the common channel (e.g., a channel for common transmissions) (602).

In some cases, the first indication can indicate to disable (e.g., false state, off state, deactivated state, etc.) the common channel forwarding functionality (608). In some cases, the SN 302 can determine the time domain resource associated with the first indication (e.g., sent from the BS 102 in the same or different signal). The time domain resource can be determined via explicit indication or implicit indication. Within or during time domain resource, the SN FU can be off according to the common channel pattern (610). During the off state, the SN FU may not forward common channel signals, until the SN FU is turned on/activated. For instance, the SN FU can be kept off until at least one of: the SN 302 (e.g., SN CU) receives another first indication (or another indication) to change the common channel forwarding functionality; the on/off state of SN FU outside the common channel pattern can be determined according to the second indication.

In some implementations, the first indication can indicate to enable (e.g., activate state, true state, on state, etc.) the SN FU (e.g., common channel forwarding functionality) (604). In some cases, the SN 302 can receive or determine an associated time domain resource (e.g., associated with the first indication, which can be via a table lookup operation). The time domain resource can be implicitly or explicitly determined. In this case, within the time domain resource, SN FU can be on according to the common channel pattern (e.g., enabled for forwarding common channel signals) (606). The SN FU can be on until SN CU receives another first indication to change its common channel forwarding functionality. In various aspects, the on/off state of SN FU outside the common channel pattern can be determined according to the second indication.

For example, the SN 302 can receive the second indication (e.g., in the same message or different message as the first indication), indicating the on/off state of SN FU outside of the common channel (612). The on/off state can be indicated by explicit indication or implicit indication. The SN 302 can include the capability or be configured to support determining the on/off state of the SN FU via implicit indication, which may be controlled/indicated by the BS 102.

### Content of First Indication

The first indication can be carried in at least one of RRC message (e.g., via RRC establishment, RRC configuration, RRC reconfiguration, and/or RRC release, etc.), MAC CE, and/or DCI, among other signalings. The content/information/indication of the first indication can include at least one of the following:
1) A parameter to configure the on/off states, such as enable/true/on/activated state or disable/false/off/deactivated state. The time domain resource may not be included or associated with this parameter. Because the time domain resource is not included, it implies that the on or off state can be applied on SN FU until SN CU receives the next indication (e.g., another first indication via RRC reconfiguration, among other signalings).
2) A first parameter to configure at least one of the on state or the off state of the SN FU (e.g., configure the enabling or disabling of the signal forwarding), and a second parameter to configure the associated time domain resource (e.g., time domain resource for enabling or disabling of the signal forwarding). The first and second parameters can be a part of the same indication from the BS 102.
   a. The second parameter (e.g., configuring the time domain resource) may include at least one of a start time, a pattern, a start and length indicator value (SLIV), a time offset, a time domain resource allocation (TDRA) index, a duty cycle, a duration and/or a periodicity, etc.
   b. The first parameter (e.g., indication of the on state or off state) can be applied for the SN FU according to the associated time domain resource in the second parameter.
3) A parameter to configure a time domain resource.
   a. In the case that this parameter is provided or included as part of the first indication, the parameter may include at least one of a start time, a pattern, a SLIV, a time offset, a TDRA index, a duty cycle, a duration, and/or a periodicity, etc.
   b. For example, the explicit on/off state indication may not be included as part of the first indication. In this case, the on or off state may be incorporated into the time domain resource indication, such that the first indication includes a time domain resource without the explicit on/off state indication. Within the time domain resource, the whole channel forwarding functionality and/or common channel forwarding functionality can be enabled. Within the time domain resource can refer to during a duration of the time domain resource. Outside of the time domain resource, the whole channel forwarding functionality and/or common channel forwarding functionality can be disabled. Outside of the time domain resource can refer to outside the duration of the time domain resource.

### Content of Second Indication

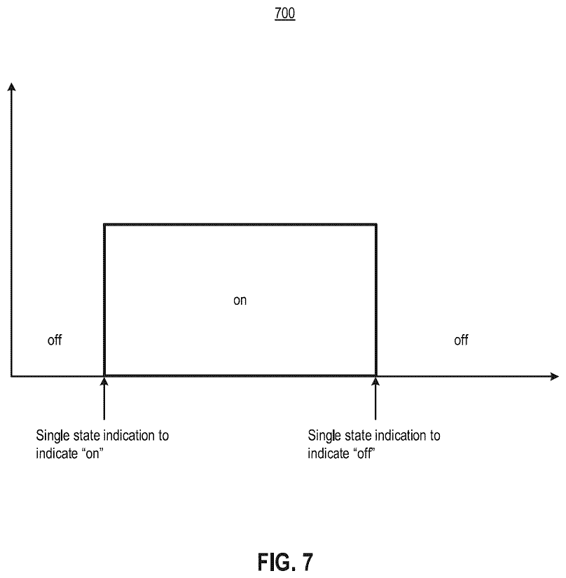

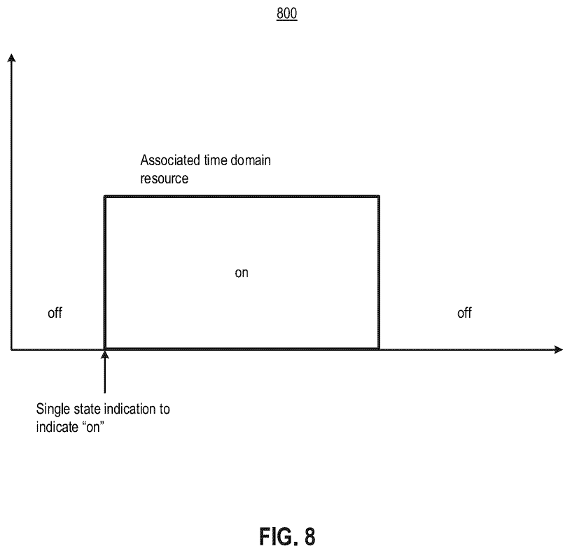

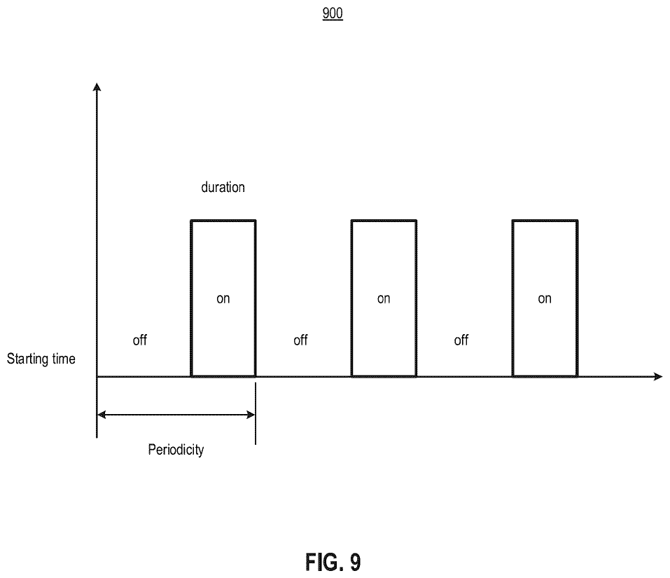

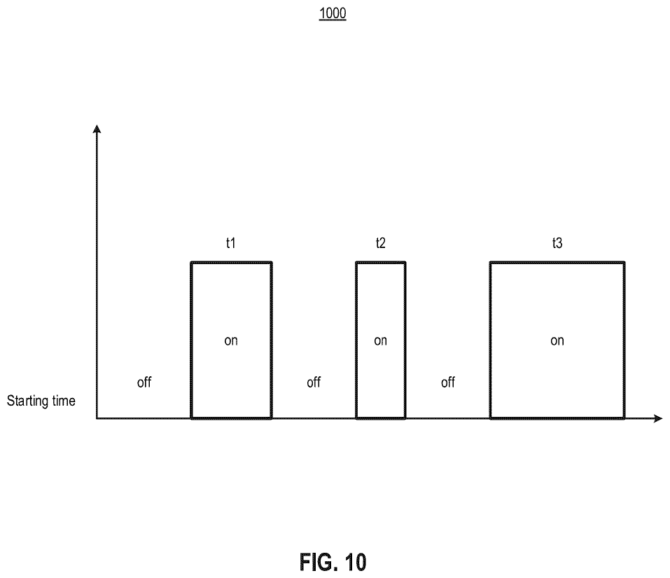

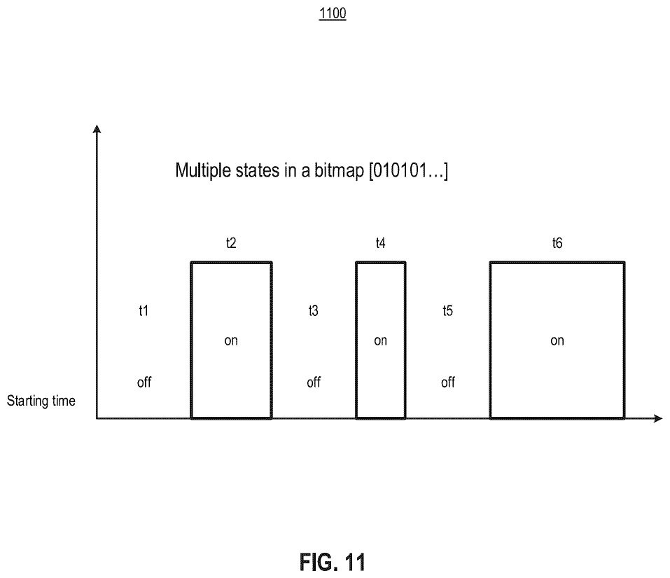

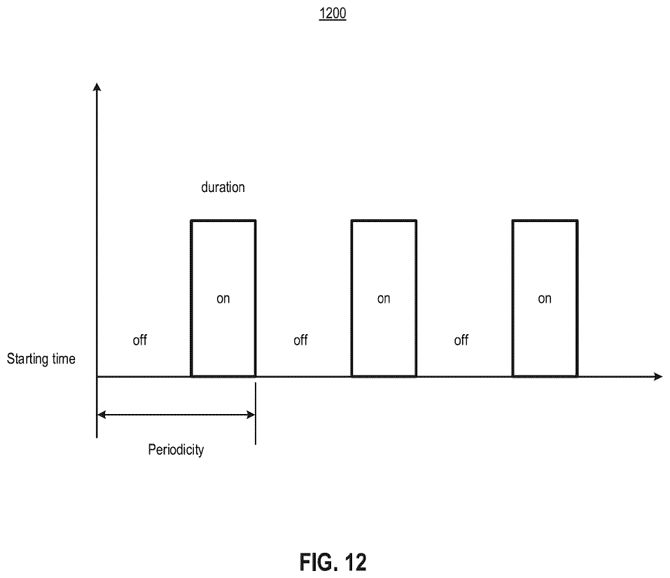

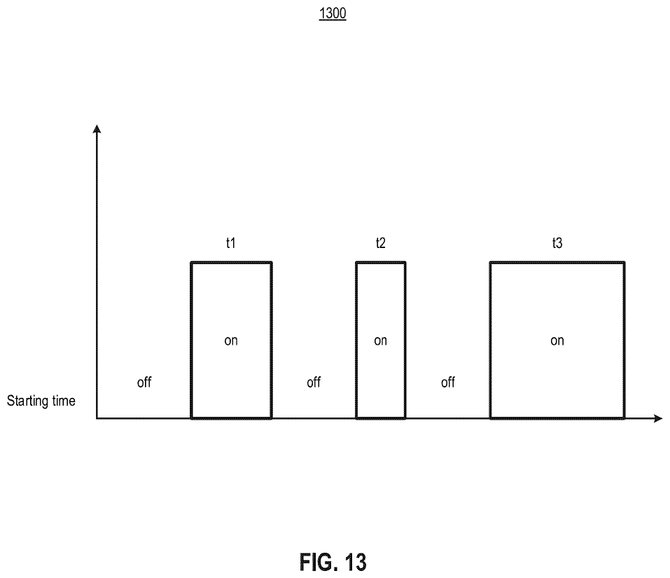

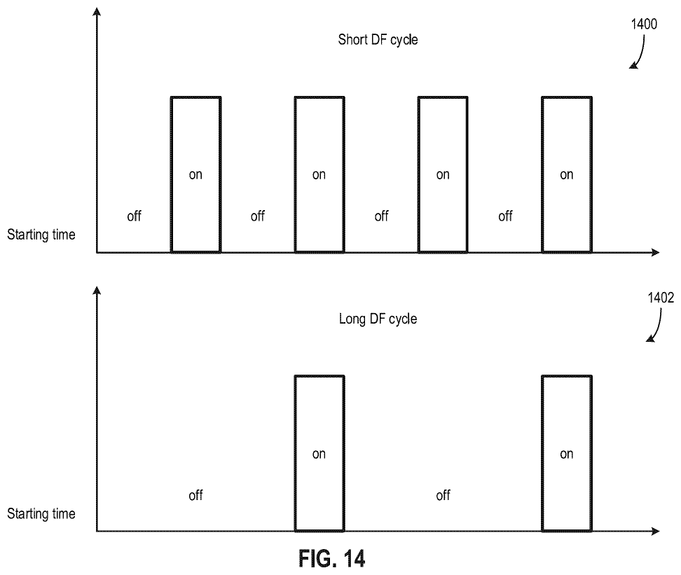

The second indication may be carried/included/contained in at least one of RRC signal/message (e.g., via RRC establishment, RRC configuration, RRC reconfiguration, and/or RRC release), MAC CE, and/or DCI. The on/off indication of the second indication may not affect the common channel forwarding functionality. In some implementations, the BS 102 may not send the second indication or the SN 302 may ignore the second indication in cases/scenarios when the second indication is not considered when determining the on/off state of the SN FU (e.g., based on the first indication for at least one of the whole channel or common channel forwarding functionality). In various arrangements, the content of the second indication can include at least one of:
1) Explicit indication, which can include or correspond to at least one of:
   a. Single on/off state indication/indicator. The single on/off state indication can indicate whether to change (or in some cases, maintain) the state of SN FU to on/enabled/activated or off/disabled/deactivated (e.g., changing the on/off state of the SN 302). This single on/off state indication/indicator may not affect the common channel forwarding, for example.
      i. Because the single on/off state indication does not include or not associated with a time domain resource, the on or off state can be implied to be continuously applied to the SN 302, such as until the SN 302 receives the next indication (e.g., next first indication via RRC message) or another second indication (e.g., via DCI).
      ii. For example, FIG. 7 illustrates a graph 700 of an example single state indication. As shown, when the SN FU is off and SN CU receives a single state indication indicating an on state, at epoch time (e.g., shown in FIG. 7 as the left arrow positioned at the epoch time of the on/off indication, such as the time that on/off indication is applied on the SN 302), the SN FU can be activated until the epoch time of another single state indication (e.g., shown as the right arrow). Upon receiving another single state indication (e.g., indicating a deactivated state), the SN FU can be deactivated at the epoch time of the other single state indication.
   b. Single on/off state indication/indicator associated with a time domain resource. In some implementations, the single on/off state can indicate the on or off state to change the on/off state of non-common channel signal (or UE-specific signal) forwarding for the SN 302. The single on/off state indication may not affect the common channel forwarding. The time domain resource may be configured by at least one of a start time, a pattern, a SLIV, a time offset, a TDRA index, a duty cycle, a duration, and/or a periodicity, etc.
      i. For example, FIG. 8 illustrates a graph 800 of an example single state indication associated with a time domain resource. When SN FU is deactivated and SN CU receives a single state indication to indicate activation of the SN FU associated with a time domain resource, the SN FU can be turned on at an epoch time (e.g., the position of the arrow in at least FIG. 8 refers to the epoch time of the on/off indication, such as the time that on/off indication is applied on the SN 302). The SN 302 can maintain the active or on state for the duration of the time domain resource. Subsequent to the duration of the time domain resource, the SN 302 can be deactivated or turned off.
   c. Multiple on/off states indication, each associated with a time domain resource. Each on/off state indication can indicate an on state or an off state, such as to change the activate/deactivation state of signal forwarding of the SN 302. Each of the multiple on/off states indication may not affect common channel forwarding. For example, the multiple on-off states can be carried/contained/provided in a bitmap (e.g., [11011001] is an 8 bits bitmap, where 1 can represent an on state and 0 can represent an off state, or vice versa). Although the example includes an 8 bits bitmap having a certain pattern, another bitmap having more or less number of bits can be configured/used. In another example, the multiple on/off states can be represented as all 1s (e.g., in each time domain resource, SN FU can be activated (e.g., activating the forwarding functionality), and outside of these time domain resources, SN FU can be deactivated (e.g., deactivating the forwarding functionality). In some cases, an additional bit (e.g., 1-bit) can indicate 0 or 1 for the various multiple on/off states. In some other cases, the multiple on/off states can be predefined as all 1s or all 0s, for example. In various aspects, each state (e.g., on/off state) can correspond to a time domain resource (e.g. discontinuous time domain resource, slot 1 corresponds to state 1, slots 5 and 6 correspond to state 2, etc.). In this case, the indication can include a set of time domain resources (e.g. discontinuous time domain resource), such that each time domain resource can refer to the same predefined or configured on/off state (e.g., 0 or 1).
      i. In some implementations, the multiple on/off states can be carried in a pattern. In some cases, there can be multiple predefined patterns (e.g., using a bitmap and/or a set of multiple states). In this case, in the indication, the BS 102 can configure a pattern index for the SN 302. In some other cases, the pattern can be (e.g., directly) indicated by a set of multiple states. For instance, the set may be [‘on’, ‘on’, ‘off’, ‘on’, ‘off’, etc.], which may be another type/kind of indicator similar to the bitmap.
      ii. In some cases, each on/off state can be associated with a time domain resource. In some implementations, the time domain resource may be the same for each on/off state. For instance, the indication (e.g., at least one of the multiple on/off states indication) may include a single time domain resource configured by the BS 102. The single time domain resource may apply to more than one of the multiple on-off states. In this case, the time domain resource may be configured by at least one of a start time, a pattern, a SLIV, a time offset, a TDRA index, a duty cycle, a duration, and/or a periodicity, among others. In some cases, the time domain resource may be predefined/indicated in the specification, such as 1 slot, 1 ms, 1 frame, and/or 1 sub-frame, etc.
      iii. For example, FIG. 9 illustrates a graph 900 of a first example multi states indication. The time domain resource can be configured by a duration and/or a periodicity for each duration portion/part/segment. Within or during the duration of the respective period, the corresponding state of the SN FU can be on (e.g., activated state). Outside of the duration of the respective period, the SN FU can be off (e.g., deactivated state).
      iv. In another example, FIG. 10 illustrates a graph 1000 of a second example multi states indication. The time domain resources can be configured by at least one SLIV or a set of SLIVs (e.g., include a start time and/or a length/duration). Each SLIV can correspond to a respective time domain resource. For each configured time domain resource, such as during the duration of the time domain resource, the SN FU can be activated or on, such as denoted as t1, t2, t3, etc., as shown in FIG. 10. Outside of the duration (e.g., outside of t1, t2, and/or t3), the SN FU can be deactivated.
      v. In yet another example, FIG. 11 illustrates a graph 1100 of a third example multi states indication. In this case, the time domain resources can be configured by a set of SLIVs (e.g., including a start time and a length). Each of the SLIVs can correspond to a respective time domain resource. For each configured time domain resource (e.g., denoted as t1, t2, t3, t4, t5, t6 etc., such as shown in FIG. 11), the on/off state can be indicated by the corresponding 0 or 1 in the bitmap. For simplicity, 1 can represent an active/activated state and 0 can represent an inactive/deactivated. In this case, the bitmap may be [010101 . . . ], such that the SN FU can turn on within the time domain resources corresponding to 1, and/or turn off within the time domain resources corresponding to 0 in the bitmap. The SLIV can indicate the start time for at least one of the activated state and/or deactivated state of the SN FU. The SLIV can indicate the duration for the activated state and/or deactivated state of the SN FU.
   d. One or more time domain resources. The time domain resource may be configured by or be associated with at least one of a start time, a pattern, a SLIV, a time offset, a TDRA index, a duty cycle, a duration, and/or a periodicity, etc. In this case, the time domain resource may not be associated with an explicit on/off state indication. Therefore, the on/off state (e.g., indication of the on/off state) may be incorporated into the time domain resource indication. For instance, the second indication may include one or more time domain resources. Within the time domain resource(s), the forwarding functionality can be activated (e.g., based on the configuration of at least one of the SN 302 and/or the BS 102). Outside of the time domain resource(s), the forwarding functionality can be deactivated.
      i. FIG. 12 illustrates a graph 1200 of a first example time domain resource indication. For example, the time domain resource can be configured by a duration and a periodicity (e.g., period in a cycle). Each periodicity can correspond to a duration part/portion. The state corresponding to the duration (e.g., within the duration) can be on (e.g., based on a default configuration, such as without explicit state indication). Hence, SN FU can be turned on within the duration(s) and/or off outside the duration(s).
      ii. In another example, FIG. 13 illustrates a graph 1300 of a second example time domain resource indication. The time domain resources can be configured by a set of SLIVs (e.g., including a start time and a length/duration). Each SLIV can correspond to a respective time domain resource. For each configured time domain resource, the corresponding state within the duration can default as an activated state (e.g., without explicit state indication). Therefore, SN FU can be activated during/within the duration (e.g., activated at the start time of the respective duration), and/or deactivated outside the duration (e.g., deactivated at the end time of the respective duration) of the time domain resources. As shown, the duration can correspond to t1, t2, t3, etc.
   e. DF mode (e.g., similar to discontinuous reception (DRX) mode). In the DF mode, the forwarding functionality of SN 302 can be enabled/activated discontinuously by configuring one or more parameters. For example, FIG. 14 illustrates graphs of an example DF mode with short DF cycle (e.g., graph 1400) and long DF cycle (e.g., graph 1402). For instance, in a DF mode with a short cycle, the SN FU can be activated (e.g., turned on) more frequently compared to the long cycle. At least one of the following parameters can be configured to enable discontinuous forwarding functionality of the SN 302:
      df-onDurationTimer: the duration at the start/beginning of a DF cycle;
      df-SlotOffset: the delay before starting the df-onDurationTimer;
      df-InactivityTimer: the duration after the PDCCH occasion in which a PDCCH indicates a new UL or DL transmission for the MAC entity;
      df-RetransmissionTimerDL (e.g., per DL hybrid automatic repeat request (HARQ) process except for the broadcast process): the maximum duration until a DL retransmission is received;
      df-RetransmissionTimerUL (e.g., per UL HARQ process): the maximum duration until a grant/acknowledgment/confirmation/approval for UL retransmission is received;
      df-LongCycleStartOffset: the long DF cycle and/or df-StartOffset which can represent the subframe where the long and/or short DF cycle starts;
      df-ShortCycle: the short DF cycle (e.g., may or may not be a part of the parameter(s));
      df-ShortCycle Timer: the duration/length that the UE 104 follow the short DF cycle (e.g., may or may not be a part of the parameter(s));
      df-HARQ-RTT-TimerDL (e.g., per DL HARQ process except for the broadcast process): the minimum duration before a DL assignment for HARQ retransmission is expected by the MAC entity;
      df-HARQ-RTT-TimerUL (per UL HARQ process): the minimum duration before a UL HARQ retransmission grant is expected by the MAC entity;
      ps-Wakeup: the configuration to start the associated df-onDurationTimer, such as in case DCP is monitored but not detected (e.g., may or may not be a part of the parameter(s));
      ps-TransmitOtherPeriodicCSI (e.g., may or may not be a part of the parameter(s)): the configuration to report periodic channel state information (CSI) that is not level 1 (L1)-reference signal received power (RSRP) on physical uplink control channel (PUCCH) during the time duration indicated by df-onDurationTimer, such as in the case that dynamic control point (DCP) (e.g., DCI with cyclic redundancy check (CRC) scrambled by power-saving radio network temporary identity (PS-RNTI)) is configured but the associated df-onDurationTimer is not started;
      ps-TransmitPeriodicL1-RSRP (e.g., may or may not be a part of the parameter(s)): the configuration to transmit periodic CSI that is L1-RSRP on PUCCH during the time duration indicated by df-onDurationTimer, e.g., in case DCP is configured but associated df-onDurationTimer is not started.
2) Implicit indication, which can include at least one of the following:
   a. Implicit determination by beam information.
      i. In some implementations, the beam information (e.g., in RRC, MAC CE, and/or DCI, such as provided/indicated in the second indication) can be associated with a time domain resource. In this case, the beam information can imply that the SN FU is configured to be activated/turned on within the time domain resource. For example, based on this implication, the SN FU can activate (or maintain the activated state, depending on the previous state) within the associated time domain resource. The SN FU can change to an off state or be deactivated after the time domain resource (e.g., outside the duration of the time domain resource). The time domain resource may be configured by at least one of a start time, a pattern, a SLIV, a time offset, a TDRA index, a duty cycle, a duration, and/or a periodicity, etc.
      ii. In some implementations, the beam information may not be associated with a time domain resource. In this case, according to the beam information, this can imply that the SN FU can be activated. For example, the SN FU can be turned on (or kept on, depending on the previous state) until the next on/off indication (e.g., off state indication) is received.
      iii. In various aspects, the beam information may not be associated with a time domain resource. In this case, the beam information can imply that the SN FU is configured to be activated until a predefined/predetermined/configured time duration/period/length. For example, SN FU can be turned on (or remain on, depending on the previous state) for a predefined time duration, such as 1 slot, 1 sub-frame, 1 frame, 1 ms, and/or 1 symbol. After the time duration, the SN FU can be deactivated.
   b. Implicit determination by the power control information.
      i. In various arrangements, the implicit indication can be determined by a power control value or a value related to transmission power control of SN FU (e.g., transmission control protocol (TCP) command, etc.). The power control value(s) can correspond to at least one of an absolute power control value (e.g., the exact power used by the SN FU) and/or a relative power control value, such as a deviation of a power control value. The deviation value can be added to the current power of the SN FU, such that the cumulated value can be the transmit power of SN FU (e.g., relative power control value).
      ii. In some implementations, the power control value can include at least one of a value of the DCI field, a RRC parameter, and/or MAC CE. The DCI field can be used to re-interpret a TCP command field and/or define/indicate/provide a new DCI field of power control value for SN FU. For instance, if the power control value (e.g., the value of the DCI field) and/or the cumulated power control value (e.g., the value of the DCI field added by the current power of the SN FU) is greater than or equal to the predefined/predetermined value X (e.g., a threshold power control value), the power control value and/or the cumulated power control value can indicate to activate the signal forwarding (e.g., turn on SN FU). Otherwise, the power control value or the cumulated power control value can indicate to deactivate the signal forwarding. The predefined value X can be predefined/configured/preset through/via RRC and/or OAM signaling, among other types of signaling.
      iii. In some cases, the predefined value X (e.g., threshold) can be provided/fixed/configured in the specification. In some cases, the predefined value X can be 0, such that if the power control value (e.g., the value of the DCI field) and/or the cumulated power control value (e.g., the value of the DCI field added by the current power of the SN FU) is 0, the power control value and/or the cumulated power control value can indicate to deactivate the signal forwarding. Otherwise, the power control value and/or the cumulated power control value (e.g., if greater than 0) can indicate to activate the signal forwarding. The state of activation or deactivation of the forwarding signal can be maintained until the SN CU receives the next indication indicating a different state (e.g., the next second indication, or in some cases, first indication).
   c. Implicit determination by DRX mode of SN CU (or NCR MT).
      i. When SN CU is in DRX mode (e.g., power saving mode, extended-DRX (e-DRX) mode, etc.), within the active time (or the “on” time duration) of the DRX mode, the SN FU can be turned on (e.g., forwarding functionality of SN is activated). Outside of the active time (e.g., outside of the “on” time duration) of the DRX mode, SN FU can be turned off (e.g., forwarding functionality of SN is deactivated).

### Examples of Combinations of Signaling for the Indications

In various arrangements, different combinations of the signaling techniques/methods can be used to carry the first indication and the second indication, configured for determining the on/off state of the SN 302 (e.g., SN FU). Some of the examples can include at least the following:
1) The first indication can be carried in RRC message/signaling, and the second indication can be carried in DCI signaling.
2) The first indication can be carried in RRC signaling, and the second indication can be carried in RRC signaling.
3) The first indication can be carried in RRC signaling, and the second indication can be carried in MAC CE signaling.
4) The first indication can be carried in DCI signaling, and the second indication can be carried in DCI signaling.
5) The first indication can be carried in MAC CE signaling, and the second indication can be carried in DCI signaling.

Other combinations of the signaling methods for carrying the first and second indication (e.g., among other indications) can be considered/provided, and are not limited to the combination indicated in the aforementioned examples.

### Combinations of SN Behavior/Characteristic for First Indication and Second Indication

In various arrangements, different combinations of characteristics/behaviors can be configured for the SN 302. For example, the first indication can disable (e.g., the SN 302 can determine that the first indication indicates to disable) the whole forwarding functionality, and the second indication may not affect the on/off state or the forwarding functionality (e.g., not taken into effect). In this case, the first indication can disable the whole forwarding functionality, such that the SN FU can remain in an off state until SN CU receives another indication (e.g., another first indication or message). In various aspects, because the second indication may not be utilized or may not affect the on/off state, in this case, the SN CU may not receive a second indication (e.g., the BS 102 may not transmit the second indication). In some implementations, because the second indication does not affect the on/off state, in this case, SN CU can ignore the second indication if received from the BS 102, such that the on/off state indication from the second indication is not taken into effect.

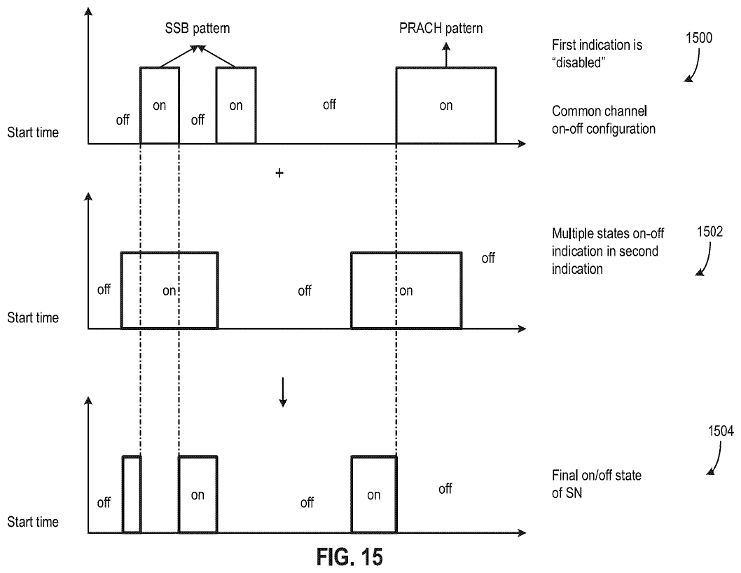

In another example, the first indication can disable the common channel forwarding functionality (e.g., signal forwarding for a channel of common transmissions), and the second message can change the on/off state of SN FU outside of the common channel pattern. Referring to FIG. 15, depicted are graphs 1500, 1502, 1504 of an example combination of whole and/or common channel forwarding functionalities. For instance, the first indication can indicate to disable common channel forwarding functionality, such as shown in graph 1500. In graph 1500, the “on” represents the disabling of the forwarding functionality. As such, the SN FU can be off within the common channel pattern (e.g., indicated as “on” in graph 1500), such as until SN CU receives another indication (e.g., first indication). Graph 1502 can include the pattern provided by the second indication. As shown, in graph 1504, the patterns of the first and second indications can be combined. Because the second indication may not change the state of SN 302 within the common channel pattern, the disabling pattern from the first indication can be reflected in the final on/off state for the SN 302. Outside of the pattern from the first indication, the activation pattern from the second indication can be applied tot the final on/off state for the SN 302, such as shown in graph 1504.

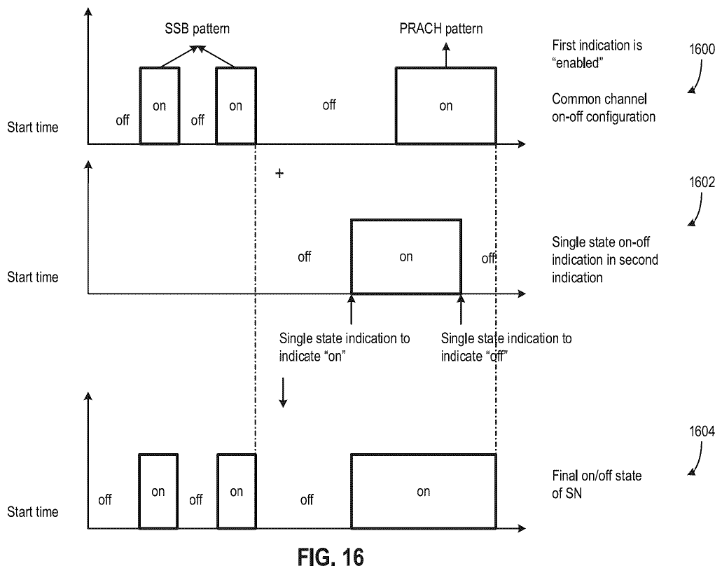

In various examples, the first indication can indicate to enable the whole channel forwarding functionality and/or common channel forwarding functionality, and the second indication can include a single state indication. In this case, if the first indication enables the whole channel forwarding functionality and/or common channel forwarding functionality, SN FU can be or remain on within the common channel pattern until SN CU receives another indication (e.g., first indication). In this case, the second indication may not alter/change the state (e.g., “on” state) of SN FU within the common channel pattern. Outside of the common channel pattern, the on/off state of SN FU can be determined according to the on/off indication (e.g., or “on” indication) of the second indication. For example, FIG. 16 illustrates graphs 1600, 1602, 1604 of another example combination of whole and/or common channel forwarding functionalities. Graph 1600 can include the common channel pattern (e.g., labeled as “on”, such as including SSB pattern, PRACH pattern, etc.) for enabling SN FU from the first indication. Graph 1602 can include an on/off indication (e.g., single state on/off indication) of the second indication. Based on the combination of the first and second patterns from the first and second indications, respectively, the final on/off state of the SN 302 can be shown in graph 1604, such that the PRACH pattern from the first indication is extended according to the on/off indication from the second indication (e.g., a portion outside the common channel pattern activates the SN FU according to the second indication).

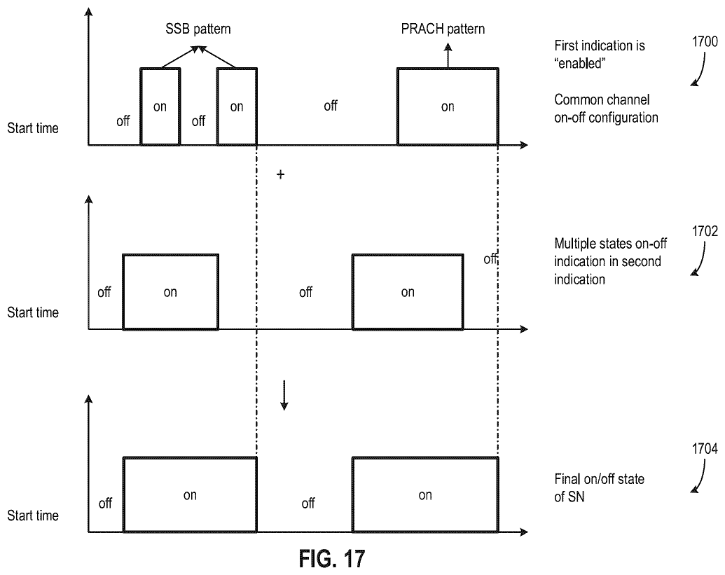

In further example, the first indication can indicate to enable whole channel forwarding functionality and/or common channel forwarding functionality, and the second indication can include multiple states on/off indication (e.g., or on indication). Referring to FIG. 17, depicted are graphs 1700, 1702, 1704 of an example combination of whole and/or common channel forwarding functionalities. In various aspects, the first indication can indicate to enable/activate the whole channel forwarding functionality and/or common channel forwarding functionality. Based on the first indication, the SN FU can be on within the common channel pattern (e.g., shown in graph 1700 as the “on” pattern) until SN CU receives another first indication. In this case, the second indication may not change the state of SN FU within the common channel pattern. Outside of the common channel pattern, the on/off state of SN FU can be determined according to the on/off indication (e.g., “on” indication or pattern) of the second indication, such as in graph 1702, for example. The final on/off state of the SN 302 can be a combination of the patterns from the first indication and the second indication. As such, in this example, the activated state indicated by the pattern from the first indication can be extended (or additional activated state occurrence(s) can be added) according to the multiple states on/off indication of the second indication, such as shown in graph 1704.

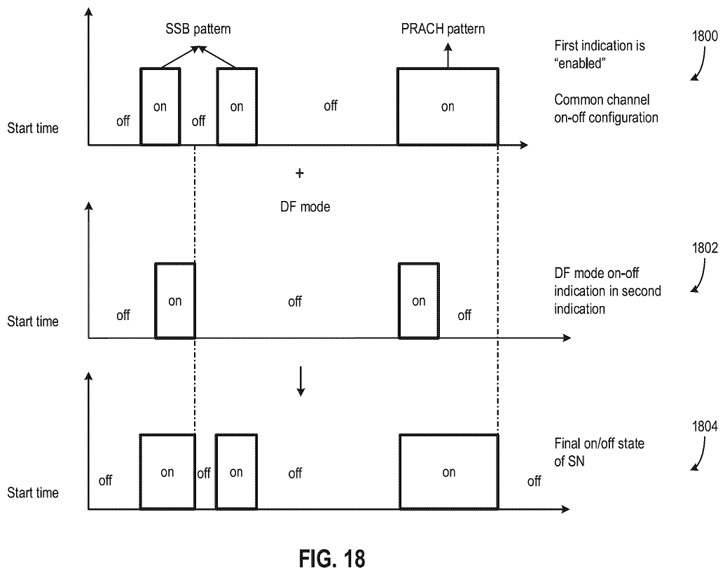

In some examples, the first indication can indicate to enable the whole channel forwarding functionality and/or common channel forwarding functionality, and the second indication can include a DF mode indication. FIG. 18 illustrates graphs 1800, 1802, 1804 of an example combination of whole and/or common channel forwarding functionalities. For example, if the first indication indicates to enable the whole channel forwarding functionality and/or common channel forwarding functionality, SN FU can be on within the common channel pattern, such as until SN CU receives another first indication. The common channel pattern of the first indication can be shown in graph 1800. In this case, the second indication may not change the state of the SN FU within the common channel pattern. Instead, the second indication can change/alter the state of the SN FU outside the common channel pattern (e.g., outside the “on” pattern of graph 1800), according to the on/off indication of the second indication. For instance, outside of the common channel pattern, the on/off state of SN FU can be determined/configured according to the on/off indication of the second indication (e.g., shown in graph 1802). Therefore, based on the combination of the pattern of the first indication and the (e.g., “on” or “activated”) indication of the second indication, the “on” state indication of the first and second indications can be combined to provide the final on/off state of the SN 302, such as shown in graph 1804. Other combinations of SN behavior for the first and second indications can be considered/configured/utilized and are not limited to the aforementioned examples.

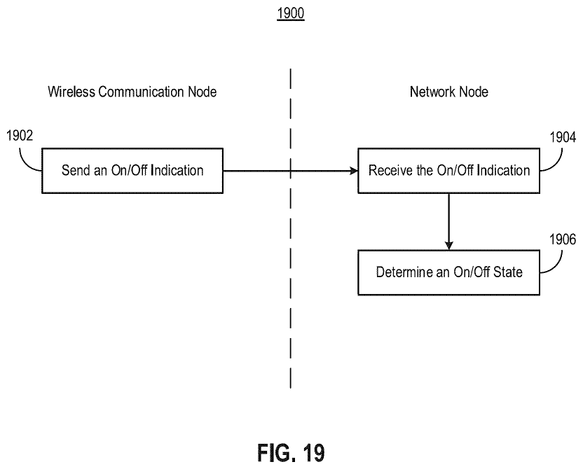

Referring now to FIG. 19 illustrates a flow diagram of a method 1900 for on/off state control for network nodes. The method 1900 may be implemented using any of the components and devices detailed herein in conjunction with FIGS. 1-18. In overview, the method 1900 may include sending on on/off indication (1902). The method 1900 can include receiving the on/off indication (1904). The method 1900 can include determining an on/off state (1906).

Referring now to operation (1902), and in some implementations, a wireless communication node (e.g., BS or gNB) can send/transmit/provide/signal an on/off indication to a network node (e.g., SN). The on/off indication can include at least one of a first indication and/or a second indication, among others. For instance, if the on/off indication includes one indication, the on/off indication can correspond to or refer to the first indication. Subsequently, referring to operation (1904), the network node can receive/obtain/acquire the on/off indication from the wireless communication node.

For example, according to the first and/or second indication, the wireless communication node can cause the network node to determine its on/off state to support signal forwarding. The signal forwarding can be between various devices within the network, such as from the wireless communication node to a wireless communication device (e.g., UE), from the wireless communication device to the wireless communication node, from the wireless communication node broadcast in various directions (e.g., to multiple devices), and/or from the wireless communication device to identify one or more other devices (or wireless communication node(s)), among others. Hence, the on/off indication can alleviate interference between network nodes and improve the energy efficiency of individual network nodes, which is utilized to improve signal coverage within the network. For instance, the semi-static indication (e.g., the first indication) can improve energy efficiency (e.g., energy saving), and/or the dynamic indication (e.g., second indication) can be configured for wireless communication device-specific scheduling of signal transmissions or communication.

In various arrangements, the network node can receive at least one (or both) of the first indication and/or the second indication via at least one of or a combination of: at least one downlink control information (DCI) signaling, at least one medium access control control element (MAC CE) signaling, at least one radio resource control (RRC), and/or at least one operations, administration and maintenance (OAM) signaling. In some cases, the first indication and the second indication may be received in a single message or multiple messages.

In some implementations, the first indication can indicate whether or not to enable the signal forwarding for at least one of: a channel of common transmissions (e.g., common channel), and/or a channel of all transmissions (e.g., whole channel). The channel of common transmissions can include at least one of: a synchronization signal block (SSB), a control resource set (CORESET) #0, a physical random access channel (PRACH), a system information block of type 1 (SIB1), and/or a group common physical downlink control channel (PDCCH), among others.

Referring now to operation (1906), the network node can determine an on/off state of the network node according to the on/off indication in response to or after receiving the on/off indication. By determining the on/off state of the network node according to the on/off indication, the network node can be configured/activated/turned on to support signal forwarding of one or more signals between the wireless communication node and the wireless communication device).

In various arrangements, the on/off state can include at least one of, an on/off state of the network node, an on/off state of a group of network nodes (e.g., multiple network nodes), an on/off state of one or more antenna ports of the network node, an on/off state of one or more beam indexes of the network node, an on/off state of one or more serving sectors of the network node, and/or an on/off state of one or more components of the network node. In some implementations, the on/off state can include the on/off state of at least one of following links: a first communication link (e.g., C2) from a wireless communication node to the network node, a second communication link (e.g., C1) from the network node to the wireless communication node, a first forwarding link (e.g., F2) from the wireless communication node to the network node, a second forwarding link (e.g., F1) from the network node to the wireless communication node, a third forwarding link (e.g., F4) from the network node to the wireless communication device, and/or a fourth forwarding link (e.g., F3) from the wireless communication device to the network node.

In some implementations, the network node can determine that the first indication) indicates to disable/turn off the signal forwarding (e.g., forwarding functionality). The first indication may refer to the whole channel transmission. In some implementations, the first indication may refer to common channel transmission. For example, when the first indication indicates to disable the signal forwarding, the network node may ignore the second indication when determining the on/off state (e.g., pattern) of the network node to support the signal forwarding. In some cases, the wireless communication node may withhold sending (e.g., delay or not send) the second indication to the network node. In this case, the network node may not receive the second indication.

In some implementations, if the first indication indicates to disable the signal forwarding, at least one of the following can occur. The signal forwarding can be disabled within a duration/length of a time domain resource associated with the first indication (e.g., a lookup can be performed to find the time domain resource associated with the first indication, among other techniques to identify the associated time domain resource). The time domain resource can be implicitly determined or explicitly determined. In some cases, the signal forwarding can remain disabled until another indication (e.g., first indication) is received that indicates to enable the signal forwarding (e.g., turn on signal forwarding). For instance, the signal forwarding can remain disabled if another indication indicates to disable the signal forwarding.

In various arrangements, the network node may determine that the first indication indicates to enable the signal forwarding. For example, when the first indication indicates to enable the signal forwarding, the network node may determine the on/off state of the network node according to the second indication's overriding or changing/modifying/adjusting/configuring of the first indication's enablement of the signal forwarding. For instance, when the first indication enables signal forwarding, the on/off state of the network node can be determined (e.g., override or revised/updated) by the second indication, in some cases.

In some implementations, when the first indication indicates to enable the signal forwarding, the network node may determine the on/off state of the network node according to an on state of an on/off pattern for a channel of common transmissions (e.g., common channel pattern). In some cases, the network node can determine the on/off state of the network node by adding an on portion of the on/off pattern of the channel of common transmissions, to non-overlapping on portions indicated by the second indication. For instance, the on portion indicated by the first indication can be added to the non-on (e.g., non-overlapping) portion(s) indicated by the second indication to determine the final pattern or on/off state for the network node. In some cases, the on portion(s) indicated by the second indication can be added to the pattern indicated by the first indication, for example.

In various arrangements, when the first indication indicates to enable the signal forwarding, at least one of the following can occur. The signal forwarding can be enabled within a duration of a time domain resource associated with the first indication. The time domain resource can be implicitly determined or explicitly determined. In some cases, the signal forwarding may remain enable until at least one of: another first indication and/or the second indication is received that indicates to disable the signal forwarding. In some implementations, if the first indication indicates to enable the signal forwarding, during an on state of the network node (e.g., SN FU), the second indication can also change the on/off state (e.g., “on” state pattern of the first indication).

In various aspects, the first indication can include at least one of: a first parameter and/or a second parameter. The first parameter can be to configure the enabling or disabling of the signal forwarding. The second parameter can be to configure a time domain resource for the enabling or disabling of the signal forwarding. In some implementations, the first indication may include only the first parameter, only the second parameter, or both the first and second parameters. In some implementations, the second parameter can include at least one of: a start time, a pattern, a start and length indicator value (SLIV), a time offset, a time domain resource allocation (TDRA) index, a duty cycle, a duration, and/or a periodicity.

In some arrangements, the on/off indication (or the second indication) can include at least one of: an indicator to enable or disable the signal forwarding, an indicator to enable or disable the signal forwarding, the indicator (e.g., single state indication) associated with a time domain resource, various indicators (e.g., multiple states indication) to enable or disable the signal forwarding, one or more time domain resources for the enabling or disabling of the signal forwarding, one or more parameters for discontinuous activation (e.g., DF) of the signal forwarding, beam information that is associated with a time domain resource, beam information that is not associated with any time domain resource, power control information, and/or a configuration of discontinuous reception (DRX) for the network node.

In some implementations, the various indicators to enable or disable the signal forwarding can include a bitmap. For example, a “0” if present in the bitmap can indicate to enable the signal forwarding, and a “1” if present in the bitmap can indicate to disable the signal forwarding, or vice versa. In some cases, the various indicator can include “1” for each of the indicators, where each “1” can indicate to enable the signal forwarding. In some cases, the various indicator can include “0” for each of the indicators, where each “0” can indicate to disable the signal forwarding. In some implementations, the various indicator can include a set of on/off states, such as at least one parameter may include a set of on/off states. In some implementations, the various indicator can include a predefined on/off pattern (e.g., several patterns that may be predefined in the specification, which at least one of the patterns can be indicated, such as using pattern index, among other lookup techniques).

In some aspects, each indicator of the various indicators can be associated with a corresponding configured time domain resource (e.g., configured via RRC signaling). In some cases, all indicators of the various indicators can be associated with the same configured time domain resource, or in some cases, all indicators of the various indicators can be associated with a predefined (e.g., programmed in within the network node or according to the specification) time domain resource. In some arrangements, a time domain resource can be specified by at least one of: a start time, a pattern, a start and length indicator value (SLIV), a time offset, a time domain resource allocation (TDRA) index, a duty cycle, a duration, and/or a periodicity.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method comprising:
receiving, by a network node, an on/off indication from a wireless communication node; and
determining, by the network node according to the on/off indication, an on/off state of the network node to support signal forwarding of one or more signals.

2. The method of claim 1, wherein the on/off indication comprises a first indication and a second indication.

3. The method of claim 1, wherein the on/off state comprises at least one of:
an on/off state of the network node;
an on/off state of a group of network nodes;
an on/off state of one or more antenna ports of the network node;
an on/off state of one or more beam indexes of the network node;
an on/off state of one or more serving sectors of the network node; or
an on/off state of one or more components of the network node.

4. The method of claim 1, wherein the on/off state further comprises the on/off state of at least one of following links:
a first communication link from a wireless communication node to the network node;
a second communication link from the network node to the wireless communication node;
a first forwarding link from the wireless communication node to the network node;
a second forwarding link from the network node to the wireless communication node;
a third forwarding link from the network node to the wireless communication device; or
a fourth forwarding link from the wireless communication device to the network node.

5. The method of claim 2, comprising:
receiving, by the network node, one or both of the first indication and the second indication via at least one of: at least one downlink control information (DCI) signaling, at least one medium access control control element (MAC CE) signaling, at least one radio resource control (RRC) or at least one operations, administration and maintenance (OAM) signaling.

6. The method of claim 2, wherein the first indication indicates whether or not to enable the signal forwarding for:
a channel of common transmissions, or
a channel of all transmissions.

7. The method of claim 6, wherein the channel of common transmissions includes at least one of: a synchronization signal block (SSB), a control resource set (CORESET) #0, a physical random access channel (PRACH), a system information block of type 1 (SIB1), or a group common physical downlink control channel (PDCCH).

8. The method of claim 1, comprising:
determining, by the network node, that the first indication indicates to disable the signal forwarding.

9. The method of claim 8, wherein when the first indication indicates to disable the signal forwarding:
the network node ignores the second indication when determining the on/off state of the network node to support the signal forwarding, or
the wireless communication node withholds sending the second indication to the network node.

10. The method of claim 8, wherein at least one of:
the signal forwarding is disabled within a duration of a time domain resource associated with the first indication, the time domain resource being implicitly determined or explicitly determined, or
the signal forwarding remains disabled until another first indication is received that indicates to enable the signal forwarding.

11. The method of claim 2, comprising:
determining, by the network node, that the first indication indicates to enable the signal forwarding.

12. The method of claim 11, further comprising:
determining, by the network node when the first indication indicates to enable the signal forwarding, the on/off state of the network node according to the second indication's overriding or changing of the first indication's enablement of the signal forwarding.

13. The method of claim 11, further comprising:
determining, by the network node when the first indication indicates to enable the signal forwarding, the on/off state of the network node according to an on state of an on/off pattern for a channel of common transmissions.

14. The method of claim 11, comprising determining the on/off state of the network node by adding an on portion of the on/off pattern of the channel of common transmissions, to non-overlapping on portions indicated by the second indication.

15. The method of claim 11, wherein at least one of:
the signal forwarding is enabled within a duration of a time domain resource associated with the first indication, the time domain resource being implicitly determined or explicitly determined, or
the signal forwarding remains enabled until at least one of: another first indication or the second indication is received that indicates to disable the signal forwarding.

16. The method of claim 2, wherein the first indication comprises at least one of:
a first parameter to configure the enabling or disabling of the signal forwarding, or
a second parameter to configure a time domain resource for the enabling or disabling of the signal forwarding.

17. The method of claim 16, wherein the second parameter comprises at least one of: a start time, a pattern, a start and length indicator value (SLIV), a time offset, a time domain resource allocation (TDRA) index, a duty cycle, a duration or a periodicity.

18. A method comprising:
sending, by a wireless communication node to a network node, an on/off indication; and
causing the network node to determine, according to the on/off indication, an on/off state of the network node to support signal forwarding of one or more signals.

19. A wireless communication node, comprising:
at least one processor configured to:
send, via a transmitter to a network node, an on/off indication; and
causing the network node to determine, according to the on/off indication, an on/off state of the network node to support signal forwarding of one or more signals.

20. A network node, comprising:
at least one processor configured to:
receive, via a receiver, an on/off indication from a wireless communication node; and
determine, according to the on/off indication, an on/off state of the network node to support signal forwarding of one or more signals.
